(19) United States
(12) Patent Application Publication
(10) Pub. No.: US 2017/0099853 A1
(43) Pub. Date: Apr. 13, 2017

(54) FEEDER FOR MACHINES FOR WRAPPING SHEET-LIKE PRODUCTS

(71) Applicant: GIMA S.P.A., Zola Predosa (IT)

(72) Inventor: Lorenzo MALDARELLI, Bologna (IT)

(21) Appl. No.: 15/129,096

(22) PCT Filed: May 19, 2014
(86) PCT No.: PCT/IT2014/000135

§ 371 Date: Sep. 26, 2016

(30) Foreign Application Priority Data
Mar. 26, 2014 (IT) BO2014A000166

(51) Int. Cl. A23G 4/02; B65B 11/06; B65B 61/06; B65B 41/12; B65B 61/28; B65B 65/00; B65B 11/00; B65B 35/02

(52) U.S. Cl. CPC A23G 4/02; B65B 11/004; B65B 11/06; B65B 35/02; B65B 41/12; B65B 61/28; B65B 65/006; B65B 61/06

(57) ABSTRACT

A feeder for machines for wrapping sheet-like products includes a track for supplying laminar blanks, a cutting unit for dividing the blanks into sheet-like products, and a channel for supplying a respective wrapping station with the sheet-like products. The feeder includes at least two channels arranged mutually side by side, and lead to respective mutually opposite wrapping elements of distinct wrapping stations. A sorting apparatus is interposed between the channels and the cutting unit for the selective transfer of the sheet-like products that arrive from the cutting unit to one respective channel at a time.

### TECHNICAL FIELD

The present disclosure relates to a feeder for machines for wrapping sheet-like products.

### BACKGROUND

The requirement to individually wrap sheet-like products is particularly strongly felt for chewing gum in the form of ingot-like sticks, which, inside the respective package, are individually wrapped in order to preserve their integrity and maintain a good standard of hygiene.

Packaging chewing gum in sticks involves the production of the sticks starting from larger pieces (obtained through a die punch, a shearer and the like) and subsequently passing each individual stick through a succession of stations that are designed to juxtapose the wrapping sheet and close the respective flaps around the stick itself

The speed of the subsequent operations necessary for wrapping is strongly limited by the characteristics of the product on which to operate.

In fact if the sheet-like products are delicate and/or easily deformable, they could be subject to damage if they are subjected to high accelerations and/or if they come into contact with the rigid components that carry out the folding of the flaps.

In order to overcome such drawback, when packaging chewing gum in sticks, the environment in which the wrapping operations are executed is climate controlled.

Sticks of chewing gum in fact exhibit a substantially elastomeric behavior and their rigidity is increased when their temperature is reduced.

So operating on chewing gum in sticks kept at low temperatures (in any case lower than the ambient temperature of a workplace) thus makes it possible to maintain higher wrapping speeds.

In any case, even after adopting low temperatures of the environment in which to operate, there is still a limit to the speed of the operations to wrap the chewing gum, owing to the delicate nature of the product itself (which cannot be completely eliminated by reducing the temperature).

Even adopting two or more wrapping machines placed side by side, in order to increase productivity, is not validly practicable: quite apart from the purchase cost of each individual additional wrapping machine and the corresponding additional energy consumption, there are serious problems associated with the overall space occupation (a consequence of placing multiple machines side by side) which also implies a considerable increase in the costs of cooling the environment in which these will operate.

The main aim of the present disclosure is to solve the above-mentioned drawbacks, by providing a feeder for machines for wrapping sheet-like products which has high levels of productivity.

### SUMMARY

Within this aim, the disclosure provides a feeder for machines for wrapping sheet-like products which offers reduced space occupation.

The disclosure further provides a feeder for machines for wrapping sheet-like products which makes it possible to keep operating costs low.

The present disclosure also provides a feeder for machines for wrapping sheet-like products which is low-cost, easily and practically implemented, and safe to use.

These advantages are achieved by a feeder for machines for wrapping sheet-like products of the type comprising a track for supplying laminar blanks, a cutting unit for dividing the blanks into sheet-like products and a channel for supplying a respective wrapping station with said sheet-like products, characterized in that said channels are at least two in number, are arranged mutually side by side, and lead to respective mutually opposite wrapping elements of distinct wrapping stations, a sorting apparatus being interposed between said channels and said cutting unit for the selective transfer of the sheet-like products that arrive from said cutting unit to one respective channel at a time.

Such advantages are also achieved by a wrapping machine, of the type comprising a channel for supplying sheet-like products, a series of wrapping stations and a line for the exit of wrapped products, characterized in that said supply channels are at least two in number, each one being adapted to supply sheet-like products to a respective series of wrapping stations, upstream of said supply channels at least one magazine for laminar blanks being arranged, at least one cutting unit for dividing the blanks into sheet-like products and at least one sorting apparatus for the selective transfer of the sheet-like products that arrive from said cutting unit to one respective channel at a time.

The advantages indicated previously are also achieved by adopting a wrapping process for sheet-like products, which includes:
picking up a laminar blank from a supply track;
dividing each laminar blank into sheet-like products by means of at least one respective cutting unit;
transferring selectively the sheet-like products that arrive from said cutting unit to one at a time of at least two distinct supply channels by means of a sorting apparatus;
wrapping each individual product that arrives from a respective supply channel with a respective contoured sheet by means of a series of consecutive wrapping stations that are aligned with a respective channel

### BRIEF DESCRIPTION OF THE DRAWINGS

Further characteristics and advantages of the disclosure will become more apparent from the description of a preferred, but not exclusive, embodiment of the feeder for machines for wrapping sheet-like products according to the disclosure, which is illustrated by way of non-limiting example in the accompanying drawings wherein:

FIG. 1 is a perspective view of a feeder associated with a wrapping machine according to the disclosure;

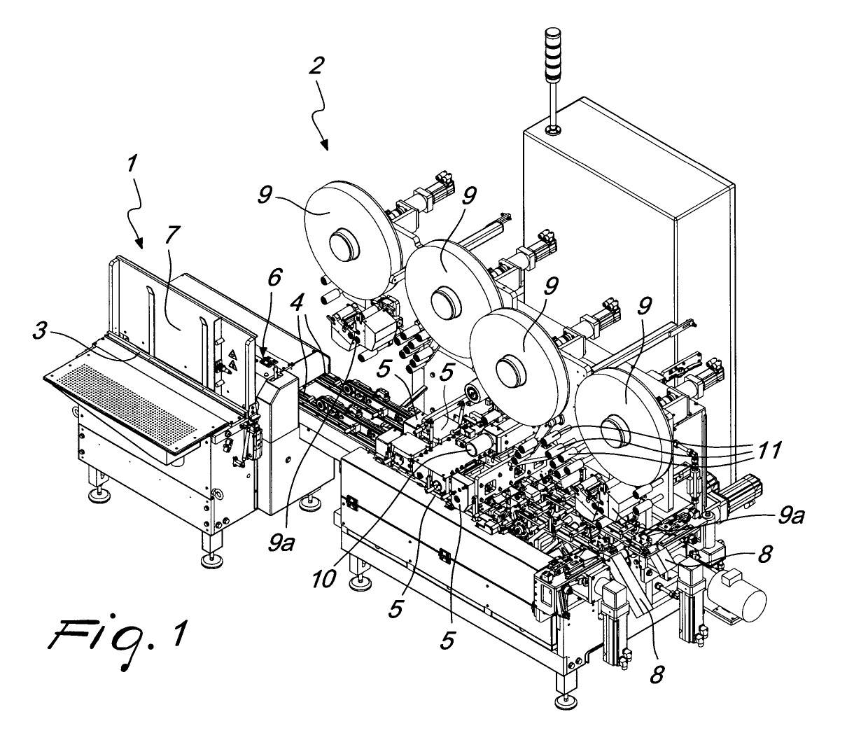

FIG. 2 is a front elevation view of the machine in FIG. 1;

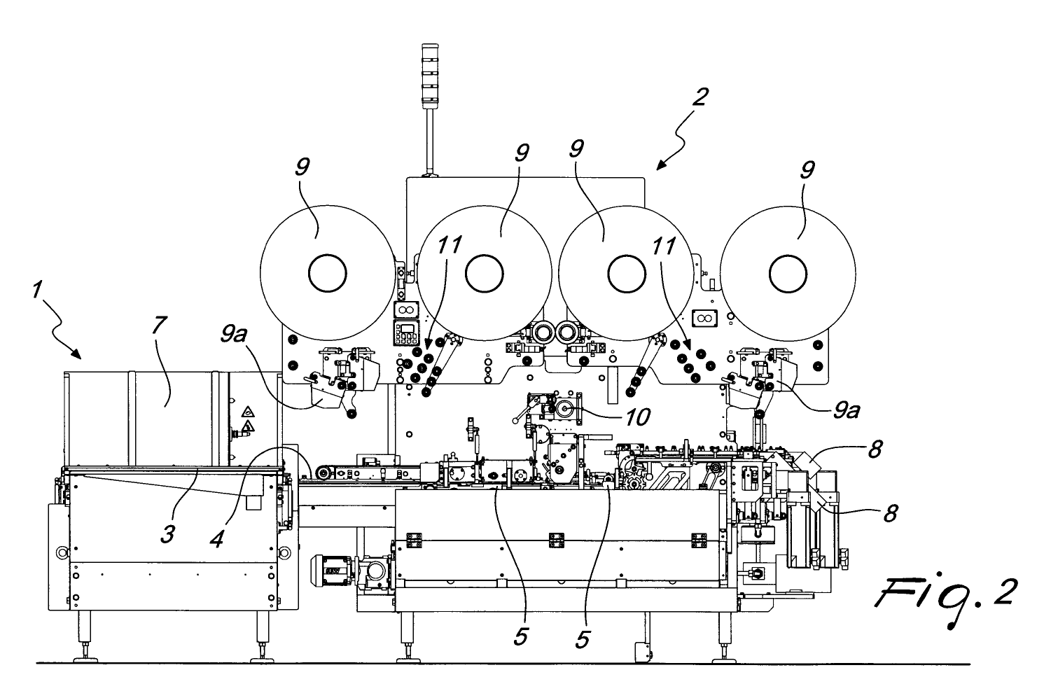

FIG. 3 is a view from above of the machine in FIG. 1;

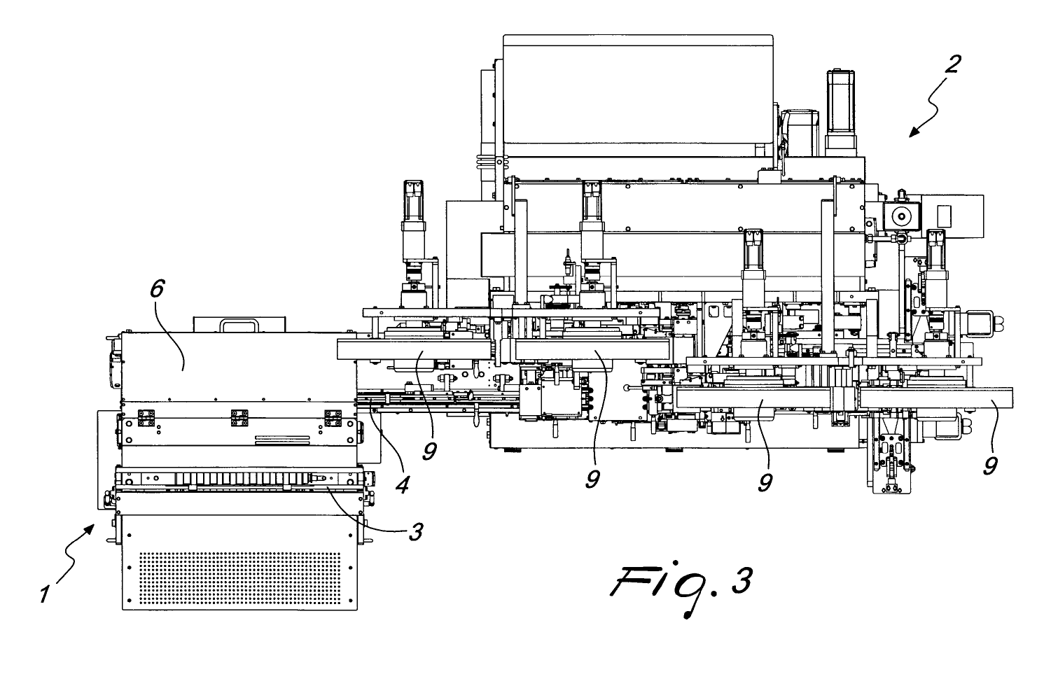

FIG. 4 is a side view of the machine in FIG. 1; and

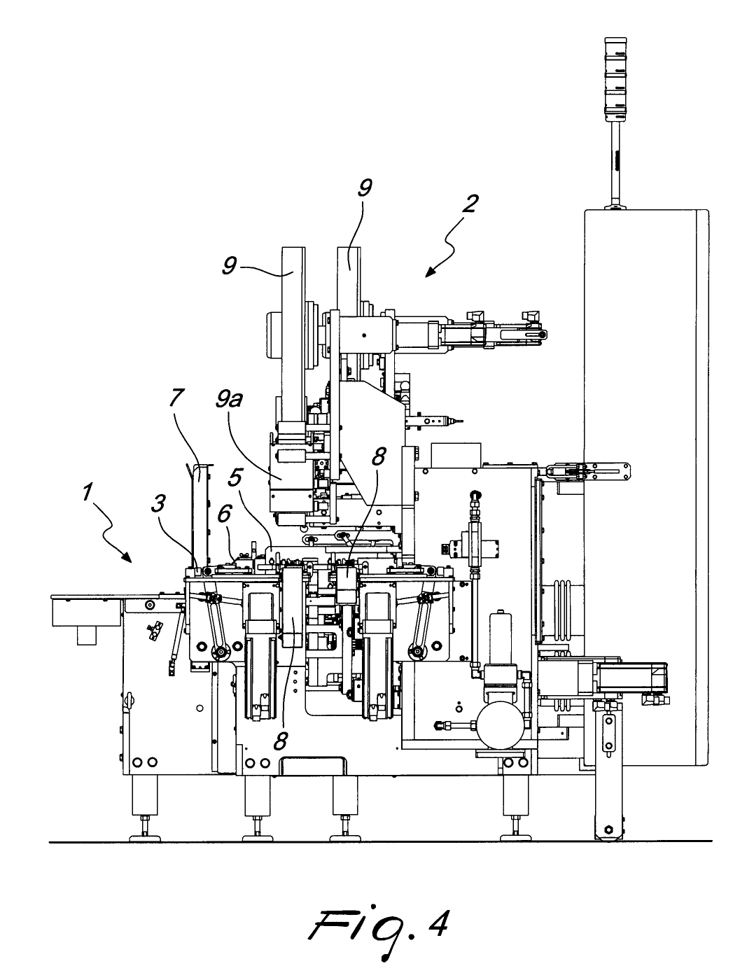

FIG. 5 is a perspective schematic view of the flow of product in the machine in FIG. 1.

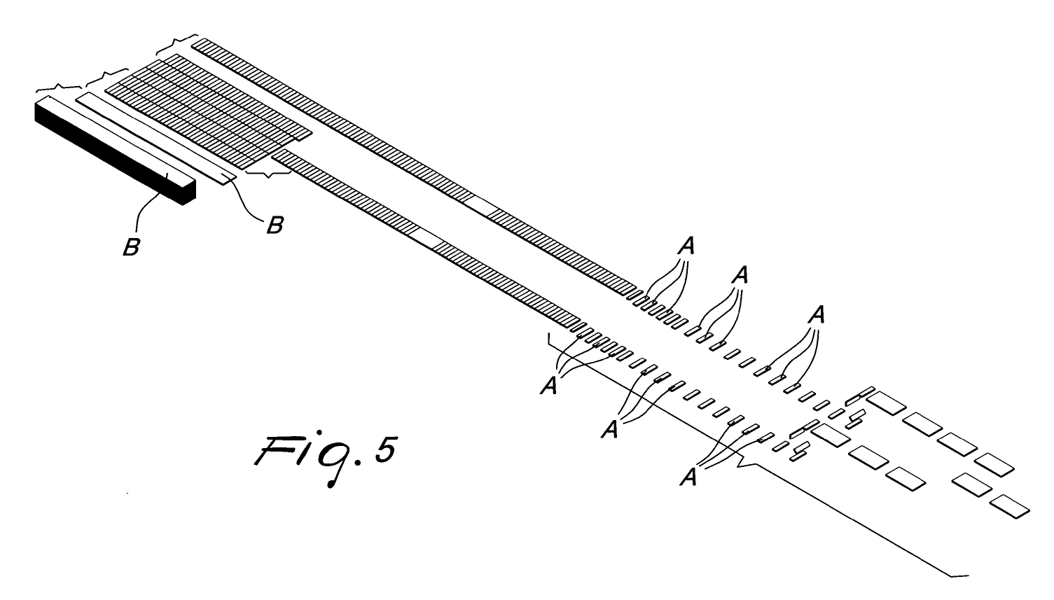

### DETAILED DESCRIPTION OF THE DRAWINGS

With particular reference to the figures, the reference numeral 1 generally designates a feeder for machines 2 for wrapping sheet-like products A.

The feeder 1 comprises a track for supplying laminar blanks B, a cutting unit 3 for dividing the blanks B into sheet-like products A and a channel 4 for supplying a respective wrapping station 5 with the sheet-like products A.

According to the disclosure, the channels 4 are at least two in number, are arranged mutually side by side, and lead to respective mutually opposite wrapping elements of distinct wrapping stations 5.

A sorting apparatus 6 is interposed between the channels 4 and the cutting unit 3 for the selective transfer of the sheet-like products A that arrive from the cutting unit 3 to one respective channel 4 at a time.

According to a particular embodiment of undoubted practical and applicative interest, the supply track is arranged downstream of an accumulation magazine 7 that comprises an area for stacking the blanks B.

The blank B arranged at the lowest level will, in such case, abut against a conveyance element for its transfer to the cutting unit 3.

According to a specific embodiment of undoubted applicative interest, the sorting apparatus 6 comprises respective deflectors, which are arranged downstream of the output of the cutting unit 3 and can be oriented selectively toward one of the channels 4.

The sheet-like product A, in output from the cutting unit 3, will thus pass along the deflector until it arrives at a respective supply channel 4.

If it is necessary to sort on a high number of channels 4 it is possible to provide specific elements for gripping and movement (of conventional type for “pick and place” applications), or adopt more complex deflectors constituted by a plurality of deflector plates which can be oriented arranged in series along predefined paths leading to different channels 4.

In order to specify the characteristics of a particularly efficient embodiment, the channels 4 can comprise respective motorized conveyor belts: each belt can be in synchronous motion with the respective wrapping station 5 to which it will deliver the products A.

Preferably non-synchronous belts are provided on which the products accumulate, queuing up: in this manner it will be possible for the subsequent wrapping stations to pick up the products in an orderly fashion and this will automatically result in synchronous operation by means of a synchronous pickup.

According to a possible implementation of the present disclosure the channels 4 will be two in number, substantially parallel, and lead to two respective series of stations 5 that will carry out (each substantially independently) the wrapping of the products A circulating on them.

The scope of the present disclosure also includes a wrapping machine 2 belonging to the known type of machine which comprises a channel 4 for supplying sheet-like products A, a series of wrapping stations 5, and an output line of individually wrapped products A.

According to the disclosure, the specific wrapping machine 2 according to the disclosure differs from those of the known type in that the supply channels 4 are at least two in number, each one being designed to supply sheet-like products A to a respective series of wrapping stations 5. Products of irregular shape or packaged imperfectly will lead to at least one discard line 8.

At least one supply track of laminar blanks B will conveniently be arranged upstream of the supply channels 4.

At least one cutting unit 3, which is adapted to divide blanks B into sheet-like products A, will intercept the supply track of blanks B, upstream of the channels 4.

At least one sorting apparatus 6 is interposed between the supply channels 4 and the cutting unit 3 for the selective transfer of the sheet-like products A that arrive from the cutting unit 3 to one respective channel 4 at a time.

Furthermore, in the machine 2 according to the disclosure, each series of wrapping stations 5 comprises an apparatus for juxtaposing a contoured sheet with respect to the product A.

Such apparatus will be surmounted by at least one storage spool 9 for a respective ribbon and by a cutting apparatus 10 for cutting the contoured sheet from such ribbon.

According to a specific application of the previously-cited embodiment, the storage spools 9 are two in number, each one being provided with respective transmission pulleys 11 for the accumulation of ribbon, of the type of a buffer.

In such case, the ribbons from the pulleys lead to respective, alternately active inputs of a device 9a that is designed to automatically join the end of a first spool 9 with the beginning of a second spool 9.

Naturally, at each channel 4 there will be respective spools 9 adapted to supply the ribbon from which to make the contoured sheets that will wrap each individual product A.

Furthermore, the pairs of spools 9 that surmount a first supply channel 4 are conveniently arranged upstream, with respect to the advancement direction of the sheet-like products A along the channels 4, of the pairs of spools 9 that surmount an additional supply channel 4.

The accompanying figures show a possible embodiment of the machine 2 which has two distinct channels 4.

According to this embodiment, which involves the presence of two channels 4, the channels will be arranged upstream of two distinct series of wrapping stations 5; each one of such two wrapping stations 5 will comprise, in turn, an apparatus for juxtaposing a contoured sheet with respect to the product A.

In conformance with the foregoing explanation, such apparatus will be surmounted by two storage spools 9 for a respective ribbon: each spool 9 will be provided with respective transmission pulleys 11 for the accumulation of ribbon, thus providing an accumulation buffer.

The ribbons will lead from such pulleys 11 to respective, alternately active, inputs of a respective cutting apparatus for cutting, from this ribbon, the contoured sheet with which to wrap a single product A. Lastly, the scope of the present disclosure covers a wrapping process for sheet-like products A which involves a sequence of consecutive steps.

A first step involves picking up a laminar blank B from a supply track. Generally the blank B will be constituted by a laminar portion of a width equal to the length of the product A and a length not shorter (and generally longer) than the sum of the widths of a preset number of products A.

However, the possibility is not ruled out that the blank B can be constituted by a continuous strip of material having a width identical with the length of each product A. In such case the continuous strip could be supplied directly by the apparatus that is designed to produce and roll the raw material that constitutes the products A (for example chewing gum).

In a second step it will be necessary to divide each laminar blank B into sheet-like products A (in particular into a preset number of sheet-like products A, by making parallel transverse cuts) by way of at least one respective cutting unit 3.

A third step involves the selective transfer of sheet-like products A coming from the cutting unit 3 to at least two distinct supply channels 4 by way of a sorting apparatus 6: such transfer of products A to the channels 4 will occur individually and selectively, i.e. product A or one set of products A will be transferred to one channel 4 at a time.

A fourth and final step involves wrapping each individual product A that arrives from a respective supply channel 4 with a respective contoured sheet, by means of a series of consecutive wrapping stations 5, each series being aligned with a respective channel 4.

Conveniently the present disclosure solves the problems explained previously, by providing a feeder 1 for machines 2 for wrapping sheet-like products A, which has high levels of productivity.

In fact the possibility of carrying out the wrapping of each individual sheet-like product A on two distinct consecutive series of stations 5, in a single machine 2, makes it possible to operate at a speed similar to that of conventional machines (which thus causes no damage to the products A, by imposing acceleration levels lower than a known limit value), but achieving a decidedly higher number of wrapped products A at its outputs (a number of wrapped products A that is potentially as much as double that of conventional machines).

It should be noted that the outputs are not shown in the accompanying figures since they conform entirely to conventional implementation solutions.

Advantageously the feeder 1 for wrapping machines 2 makes it possible to maintain reduced space occupation for the machine 2, in particular levels of space occupation similar to those of machines of the conventional type.

Conveniently, therefore, the wrapping machines 2 make it possible to keep operating costs down: this is because their low space occupation makes it possible to install them in climate controlled environments (inside which the material that constitutes the chewing gum assumes a higher stiffness and thus is easier to work with) of dimensions substantially similar to those for machines of the standard type.

Profitably, the feeder 1 and the machine 2 for wrapping sheet-like products A according to the disclosure can be implemented at a substantially low cost, being easily and practically implemented and safe in application in that they comprise components and intermediate stations that are derived from implementations of conventional apparatuses.

The disclosure, thus conceived, is susceptible of numerous modifications and variations. Moreover, all the details may be substituted by other, technically equivalent elements.

In the embodiments illustrated, individual characteristics shown in relation to specific examples may in reality be interchanged with other, different characteristics, existing in other embodiments.

In practice, the materials employed, as well as the dimensions, may be any according to requirements and to the state of the art. The disclosures in Italian Patent Application No. B02014A000166 from which this application claims priority are incorporated herein by reference.

1-10. (canceled)

11. A feeder for machines for wrapping sheet-like products, the feeder comprising a track for supplying laminar blanks, a cutting unit for dividing the blanks into sheet-like products and a channel for supplying a respective wrapping station with said sheet-like products, wherein said channels are at least two in number, are arranged mutually side by side, and lead to respective mutually opposite wrapping elements of distinct wrapping stations, a sorting apparatus being interposed between said channels and said cutting unit for the selective transfer of the sheet-like products that arrive from said cutting unit to one respective channel at a time.

12. The feeder according to claim 11, wherein said supply track is arranged downstream of an accumulation magazine that comprises an area for stacking the blanks, the blank arranged at the lowest level abutting against a conveyance element for its transfer to the cutting unit.

13. The feeder according to claim 11, wherein said sorting apparatus comprises respective deflectors, arranged downstream of the output of said cutting unit, which can be oriented selectively toward one of said channels, the sheet-like product in output from said cutting unit moving along said deflector to a respective supply channel.

14. The feeder according to claim 11, wherein said channels comprise respective motorized conveyor belts, each belt being motorized with a rule of motion that is substantially independent of the respective wrapping station, the products conveyed by said belt accumulating at the area for being picked up of the respective wrapping station.

15. A wrapping machine comprising a channel for supplying sheet-like products, a series of wrapping stations and a line for the exit of wrapped products, wherein said supply channels are at least two in number, each one adapted to supply sheet-like products to a respective series of wrapping stations, upstream of said supply channels at least one magazine for laminar blanks, at least one cutting unit for dividing the blanks into sheet-like products and at least one sorting apparatus for the selective transfer of the sheet-like products that arrive from said cutting unit to one respective channel at a time.

16. The wrapping machine according to claim 15, wherein each series of wrapping stations comprises an apparatus for juxtaposing a contoured sheet with respect to the product, said apparatus being surmounted by at least one storage spool for a respective ribbon and by a cutting apparatus for cutting said contoured sheet from said ribbon.

17. The wrapping machine according to claim 16, further including two storage spools, each storage spool having respective transmission pulleys for ribbon accumulation, of the type of a buffer, said ribbons, from said pulleys, leading to respective alternately active inputs of said cutting apparatus.

18. The wrapping machine according to claim 17, wherein the pairs of spools that surmount a first supply channel are arranged upstream, with respect to the advancement direction of the sheet-like products along said channels, of the pairs of spools that surmount an additional supply channel.

19. The wrapping machine according to claim 15, wherein said supply channels are two in number, arranged upstream of two distinct series of wrapping stations, each one of said two wrapping stations comprising an apparatus for juxtaposing a contoured sheet with respect to the product, said apparatus being surmounted by two storage spools for a respective ribbon, each spool being provided with respective transmission pulleys for the accumulation of ribbon, of the type of a buffer, said ribbons, from said pulleys, leading to respective alternately active inputs of said cutting apparatus for cutting said contoured sheet from said ribbon.

20. A wrapping process for sheet-like products, which comprises the steps of:
picking up a laminar blank from a supply track;
dividing each laminar blank into sheet-like products by means of at least one respective cutting unit;
transferring selectively the sheet-like products that arrive from said cutting unit to one at a time of at least two distinct supply channels by means of a sorting apparatus;
wrapping each individual product that arrives from a respective supply channel in a respective contoured sheet by means of a series of consecutive wrapping stations that are aligned with a respective channel.
